(19) United States
(12) Patent Application Publication
(10) Pub. No.: US 2022/0172487 A1
(43) Pub. Date: Jun. 2, 2022

(54) METHOD FOR DETECTING AN OPERATING CAPABILITY OF AN ENVIRONMENT SENSOR, CONTROL UNIT AND VEHICLE

(71) Applicant: Robert Bosch GmbH, Stuttgart (DE)

(72) Inventor: Marlon Ramon Ewert, Untergruppenbach (DE)

(21) Appl. No.: 17/441,996

(22) PCT Filed: Mar. 25, 2020
(86) PCT No.: PCT/EP2020/058292

§ 371 Date: Sep. 22, 2021

(30) Foreign Application Priority Data
Apr. 26, 2019 (DE) 10 2019 206 021.8

(51) Int. Cl. G06V 20/58; B60W 40/10; B60W 40/12

(52) U.S. Cl. CPC G06V 20/58; B60W 40/10; B60W 2554/4049; B60W 2554/4041; B60W 2420/42; B60W 40/12

(57) ABSTRACT

A method for detecting an operating capability of an environment sensor of a vehicle. The method includes: ascertaining current coordinates and current orientation of the vehicle; determining at least one object in the environment of the vehicle and a setpoint position of the object in relation to the vehicle as a function of the ascertained coordinates, the ascertained orientation, a predefined position of the environment sensor on the vehicle, and a map of the environment; detecting the environment of the vehicle using the environment sensor, and generating environment data as a function thereof; detecting an actual position of the determined object in the environment of the vehicle as a function of the environment data; and detecting an operating capability of the environment sensor and/or calibrating the environment sensor, based on the actual position of the object with the setpoint position of the object.

### FIELD

The present invention relates to a method for detecting an operating capability of an environment sensor, a control unit for executing the method and a vehicle equipped with the control unit.

### BACKGROUND INFORMATION

In order to achieve sufficient reliability in autonomous or semiautonomous driving of a vehicle on the basis of sensor data, the sensor or sensors for generating the sensor data should have a predefined accuracy. Moreover, the installation position of the sensor and an orientation of the sensor should be sufficiently known and/or a corresponding calibration of the sensor be performed. The calibration can be complex and thus may entail considerable expense already during the production of the vehicle.

An object of the present invention is to detect a function of an environment sensor on a vehicle in a more optimal manner, in particular in order to calibrate the environment sensor.

### SUMMARY

The aforementioned object may be achieved by a method in accordance with an example embodiment of the present invention as well as by a control unit in accordance with an example embodiment of the present invention and a vehicle in accordance with an example embodiment of the present invention.

The present invention relates to a method for detecting an operating capability of an environment sensor of a vehicle. In accordance with an example embodiment of the present invention, the method includes an ascertainment of current coordinates of the vehicle. For instance, the current coordinates of the vehicle are coordinates of a satellite-based navigation system, which are acquired with the aid of a sensor. In addition, the method includes an ascertainment of a current orientation of the vehicle based on the current coordinates. This current orientation of the vehicle, for instance, is a yaw angle or an orientation of the vehicle in the sense of a compass. Next, at least one object in the environment of the vehicle and a setpoint position of the object in relation to the vehicle are determined as a function of the ascertained coordinates, the ascertained orientation, a predefined position of the environment sensor on the vehicle, and a map of the environment. For instance, for a camera disposed on the right side of the vehicle in the driving direction and used as a mirror substitute, a section of the map visible to the camera is ascertained based on the ascertained orientation of the vehicle, and the object as well as the setpoint position of the object in relation to the vehicle are identified or determined in this map section, the object preferably being easily detectable or identifiable and/or located in a predefined distance range from the vehicle. The map includes at least the object and a position of the object. Preferably, the determination of the object and the setpoint position of the determined object in the environment of the vehicle is at least partly implemented with the aid of a trained machine-based detection, preferably with the aid of a neural network. In an advantageous manner, the map is a highly precise map which has a resolution of less than one meter. Moreover, a detection of the environment of the vehicle is carried out with the aid of the environment sensor of the vehicle, for instance using the camera situated on the right side of the vehicle in the driving direction. Environment data are generated as a function of the acquired environment. The environment data may preferably be generated as a function of at least two environment sensors, the environment sensors using the same type of sensor or alternatively different types of sensors; for example, the environment data are generated as a function of a camera and/or a lidar sensor and/or a radar sensor and/or an ultrasonic sensor. Next, an actual position of the determined object in the environment of the vehicle is detected or ascertained as a function of the environment data. For instance, the object is detected in a camera image by an artificial intelligence or a trained machine-based detection method or a neural network, and a distance between the object and the vehicle is ascertained based on the environment data, the environment data preferably including distance data between objects in the environment of the vehicle and the vehicle. Then, an operating capability of the environment sensor is detected or ascertained by comparing the detected or ascertained actual position of the object to the ascertained setpoint position of the object. As an alternative to the detection of the operating capability or in addition to the detection of the operating capability, the environment sensor is calibrated as a function of the actual position and the setpoint position. The present method provides the advantage that the operating capability of the environment sensor is able to be determined rapidly and cost-effectively and/or a calibration of the environment is able to be carried out during an ongoing operation without the need to install artificial markings at fixedly defined locations. The calibration of the environment sensor of the vehicle such as a camera and/or a stereo camera and/or a lidar sensor and/or a radar sensor and/or an ultrasonic sensor is advantageously carried out at least with a precision that is sufficiently accurate to reliably represent an environment model which is descriptive and without artefacts and/or to realize a semiautomatic or fully automatic driving function as a function of the environment sensor with at least adequate reliability.

In one preferred embodiment of the present invention, the ascertainment of the coordinates of the vehicle is carried out as a function of acquired signals, which are received with the aid of a location sensor for a global satellite navigation system, and/or as a function of at least one camera image from a vehicle camera, and/or as a function of acquired distance data between the vehicle and objects in the environment of the vehicle, and/or as a function of odometry data of the vehicle. This embodiment, in particular when combining the dependencies, advantageously allows for a highly precise ascertainment of the coordinates of the vehicle. Alternatively or additionally, the ascertainment of the coordinates of the vehicle is realized as a function of at least a certain propagation time of an acquired Car-to-X communications signal between the vehicle and a stationary infrastructure device.

In a further preferred embodiment of the present invention, the ascertainment of the orientation of the vehicle is performed as a function of signals from a magnetometer and/or as a function of signals from at least one inertial measuring unit and/or as a function of a characteristic of ascertained coordinates of the vehicle, in particular ascertained across a predefined time span. This embodiment, in particular when combining the dependencies, advantageously allows for a highly precise ascertainment of the orientation of the vehicle.

In a further refinement of the present invention, the ascertainment of the coordinates and/or the ascertainment of the orientation of the vehicle additionally take(s) place as a function of received position information, the received position information being sent out or transmitted by an infrastructure monitoring device in the environment of the vehicle. For instance, the position information is acquired with the aid of a distance sensor system of the infrastructure monitoring device and, in one optional embodiment, the position information additionally includes information about the orientation of the vehicle. The infrastructure monitoring device is stationary and/or the location of the infrastructure monitoring device is precisely known. The data acquired with the aid of the distance sensor system or the acquired infrastructure information or acquired position information is sent or transmitted to the vehicle. For instance, the infrastructure monitoring device as the distance sensor system includes a lidar sensor and/or a stereo camera provided with a corresponding evaluation electronics. In an advantageous manner, the ascertainment of the coordinates and/or the ascertainment of the orientation as a function of the transmitted position information is/are therefore especially precise in this embodiment.

In one embodiment of the present invention, the location of the object indicated on the map has an accuracy of less than one meter. The accuracy of the position of the object on the map preferably amounts to less than 10 centimeters and, especially preferably, is less than or equal to one centimeter. Because of the high accuracy of the map or the position of the object, the operating capability of the environment sensor is advantageously able to be identified in a precise rapid and also reliable manner.

In one preferred further refinement of the present invention, the setpoint position of the determined object does not drop below a predefined distance of the object from the vehicle. In an advantageous manner, the accuracy of the map or the position of the object is therefore generally less relevant for detecting or ascertaining the operating capability of the environment sensor. The method consequently becomes considerably more robust in this further refinement. Moreover, this advantageously results in the technical effect that the operating capability of the environment sensor is able to be determined very precisely.

The detection of the actual position of the determined object in the environment of the vehicle preferably takes place as a function of the environment data, at least partly with the aid of a trained machine-based detection, preferably using a neural network. Because of the trained machine-based detection or an artificial intelligence, objects are able to be detected in a rapid and reliable manner. In an advantageous manner, the actual position of the detected object can then be easily read out from the environment data.

In another embodiment of the present invention, after the operating capability of the environment sensor has been detected, the environment sensor is deactivated as a function of the detected operating capability. For example, this advantageously avoids an imprecise display of an environment model with image artefacts and/or an unreliable semiautomatic or fully automatic driving function as a function of a faulty operation of the environment sensor.

In a further embodiment of the present invention, an activation of a safety sensor and/or an alternative environment monitoring system of the vehicle is carried out as a function of the detected operating capability, in particular a faulty operating capability, the safety sensor at least partly replacing the environment sensor. This advantageously avoids an imprecise display of an environment model with image artefacts and/or an unreliable semiautomatic or fully automatic driving function as a function of a faulty operation of the environment sensor, the environment model being displayed as a function of an environment of the vehicle acquired with the aid of the safety sensor and/or the alternative environment monitoring system, and/or a semiautomatic or fully automatic driving function being carried in an at least sufficiently satisfactory manner as a function of the environment of the vehicle acquired with the aid of the safety sensor and/or the alternative environment monitoring system.

In addition, after the operating capability of the environment sensor has been detected, an adaptation of a display of an environment model for a user of the vehicle optionally takes place as a function of the detected operating capability. In this way, the display of the environment model is advantageously adapted to the detected operating capability. In a detected malfunction, for instance, an indicated abstraction degree of the environment model is advantageously increased by this step.

It may furthermore be provided that after the operating capability of the environment sensor has been detected, a control of a steering system of the vehicle and/or of a drive motor of the vehicle or a speed of the vehicle is/are adapted as a function of the detected operating capability. For instance, this provides the advantage that a fully automated control of the vehicle is changed to a semiautomatic control, in which certain driving maneuvers such as parking of the vehicle, which are especially affected by the operating capability of the environment sensor, have to be carried out manually.

In an optional embodiment of the present method in accordance with the present invention, the method is carried out immediately after a detected accident of the vehicle. The detection of an accident preferably takes place with the aid of acceleration sensors and/or pressure sensors which are situated on the vehicle. After an accident, the present method is used to advantageously check and/or calibrate each environment sensor to determine its full operating capability.

In addition, the present invention relates to a control unit, which includes a computing unit. The control unit or computing unit is designed to be connected to the environment sensor, and the environment sensor is designed to be placed at the predefined position of the vehicle. The environment sensor in particular is a camera (mono camera or stereo camera), an ultrasonic sensor, a radar sensor or a lidar sensor. The computing unit is set up to ascertain the current coordinates of the vehicle as a function of a signal from a location sensor of the vehicle and the current orientation of the vehicle. In addition, the computing unit is designed to determine at least the object in the environment of the vehicle and the setpoint position of the object in relation to the vehicle as a function of the ascertained coordinates, the ascertained orientation, the predefined position of the environment sensor on the vehicle, and the map of the environment. Moreover, the computing unit is designed to generate environment data as a function of the environment acquired with the aid of the environment sensor and to ascertain the actual position of the determined object in the environment of the vehicle as a function of the environment data. The computing unit is also designed to detect an operating capability of the environment sensor by comparing the actual position of the object with the setpoint position of the object.

The present invention furthermore relates to a vehicle which includes at least one location sensor for a global navigation system and an environment sensor, which is situated at a predefined position of the vehicle. The vehicle furthermore includes the control unit according to the present invention.

The vehicle is advantageously designed to receive a map from a server device, the receiving in particular taking place as a function of current coordinates of the vehicle, and a position of the object indicated on the map has an accuracy of less than one meter, the accuracy of the position of the object on the map in particular being less than 10 centimeters and, especially preferably, less than one centimeter.

In a further refinement of the present invention, the vehicle includes an odometry sensor, in particular an rpm sensor, and/or an acceleration sensor and/or a yaw rate sensor. Alternatively or additionally, the vehicle includes a communications unit which is designed to exchange data with an infrastructure monitoring device via radio or to receive position information from the infrastructure monitoring device, and/or it includes a Car-to-X communications unit which is designed to receive a Car-to-X communications signal or data from a stationary infrastructure device. In this way the vehicle is advantageously designed to ascertain the current coordinates of the vehicle and/or the current orientation of the vehicle in a very precise manner.

Additional advantages result from the following description of exemplary embodiments with reference to the figures.

### BRIEF DESCRIPTION OF THE DRAWINGS

FIG. 1A shows a vehicle.

FIG. 1B shows the vehicle in a top view.

FIG. 2 shows a method for detecting an operating capability of an environment sensor.

FIG. 3A shows a visualization for determining at least one object in the environment,

FIG. 3B shows a visualization of the environment data with semantic information.

### DETAILED DESCRIPTION OF EXAMPLE EMBODIMENTS

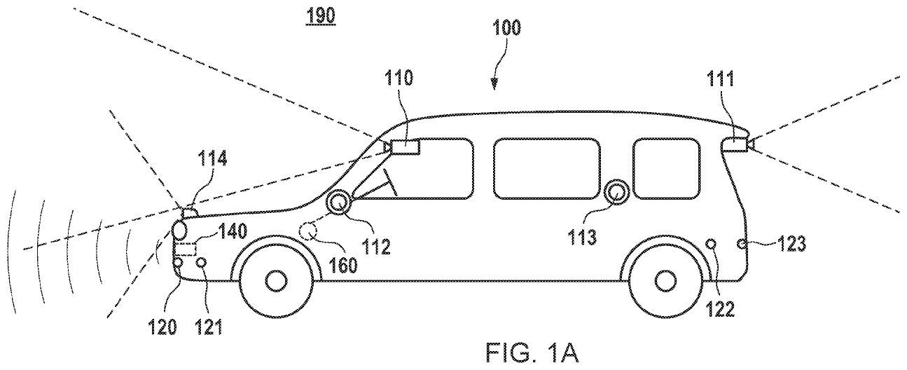

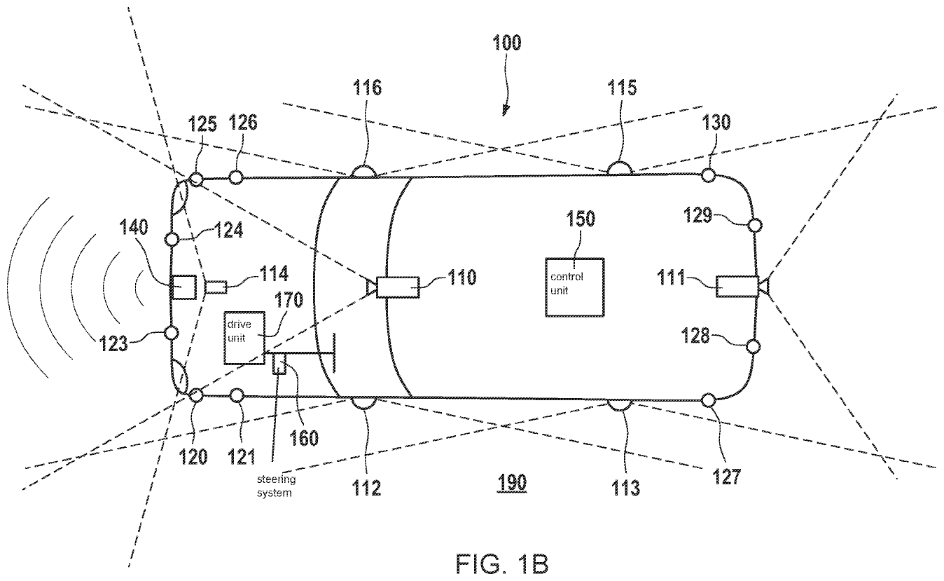

FIG. 1A and FIG. 1B schematically show a vehicle 100 having multiple environment sensors 110, 111, 112, 113, 114, 115, 116, 120, 121, 122, 123, 124, 125, 126, 127, 128, 129, 130 and 140 and a control unit 150. FIG. 1A relates to a side view of vehicle 100 and FIG. 1B relates to a top view of vehicle 100. Environment sensors 110, 111, 112, 113, 114, 115 and 116 in this exemplary embodiment are embodied as mono cameras, and environment sensors 110, 111, 112, 113, 114, 115 and 116 are embodied as wide angle cameras. Environment sensors 120, 121, 122, 123, 124, 125, 126, 127, 128, 129 and 130 are embodied as ultrasonic sensors. Environment sensor 140 is embodied as a radar sensor. Environment sensors 110, 111, 112, 113, 114, 115, 116, 120, 121, 122, 123, 124, 125, 126, 127, 128, 129, 130 and 140 each acquire a detection range or a subregion of environment 190 of vehicle 100. The detection range of respective environment sensor 110, 111, 112, 113, 114, 115, 116, 120, 121, 122, 123, 124, 125, 126, 127, 128, 129, 130 and 140 partially overlaps with a detection range of one of the other environment sensors 110, 111, 112, 113, 114, 115, 116, 120, 121, 122, 123, 124, 125, 126, 127, 128, 129, 130 and 140. The overlapping detection ranges of the environment generate a redundancy and/or greater safety and/or are used for different technical purposes such as the display of an environment model or the semiautomated driving of vehicle 100. Control unit 150 is designed to carry out a method for detecting an operating capability of at least one environment sensor 110, 111, 112, 113, 114, 115, 116, 120, 121, 122, 123, 124, 125, 126, 127, 128, 129, 130 and/or 140. In addition, control unit 150 may be designed to control the vehicle for the semiautonomous or fully autonomous driving of vehicle 100. In particular, control unit 150 is designed to control a steering system 160 of the vehicle and/or a drive unit 170 of the vehicle, for instance an electric motor, as a function of environment sensors 110, 111, 112, 113, 114, 115, 116, 120, 121, 122, 123, 124, 125, 126, 127, 128, 129, 130 and/or 140. Due to the multitude of environment sensors, a calibration or a determination of a position and/or an orientation of environment sensors 110, 111, 112, 113, 114, 115, 116, 120, 121, 122, 123, 124, 125, 126, 127, 128, 129, 130 and/or 140 following an installation of the environment sensors on the vehicle is complex, in particular because the demands on an accuracy of the determination of a position and orientation of the environment sensors is high in some instances. Furthermore, after an accident it may happen, for example, that the orientation of one of environment sensors 110, 111, 112, 113, 114, 115, 116, 120, 121, 122, 123, 124, 125, 126, 127, 128, 129, 130 and/or 140 has changed, for instance. As a result, a generated representation of the environment model of environment 190 on a display device may possibly be faulty, that is to say, no longer corresponds to the environment, and/or the semiautonomous or fully autonomous control of vehicle 100 with the aid of control unit 150 becomes unreliable. A check of the operating capability and/or a slight calibration of environment sensors 110, 111, 112, 113, 114, 115, 116, 120, 121, 122, 123, 124, 125, 126, 127, 128, 129, 130 and/or 140 is therefore advantageous, in particular during the driving operation.

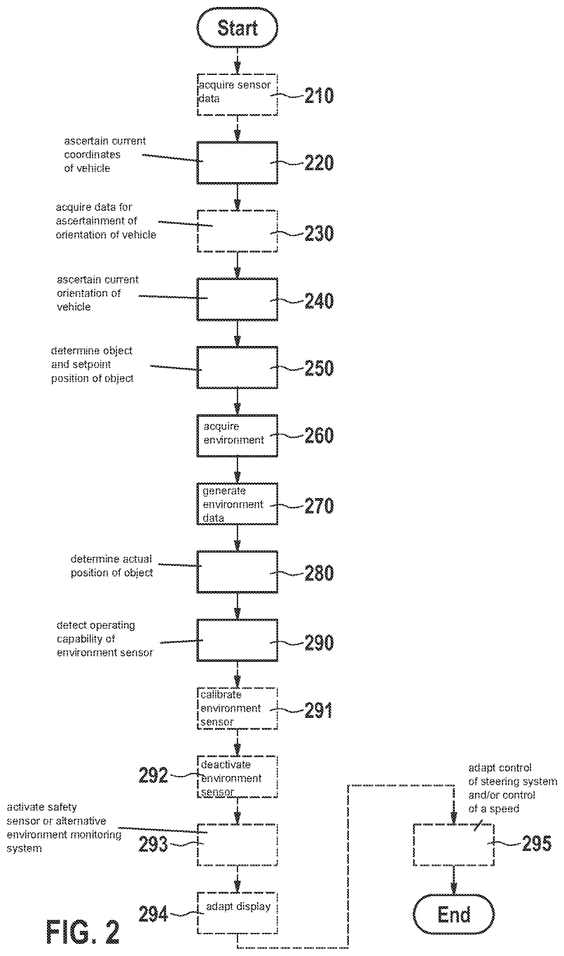

FIG. 2 shows flow diagram in connection with the method for detecting an operating capability of at least one environment sensor 110, 111, 112, 113, 114, 115, 116, 120, 121, 122, 123, 124, 125, 126, 127, 128, 129, 130 and/or 140 in the form of a block diagram. The method begins with an optional acquisition 210 of sensor data with the aid of the sensor system for the ascertainment 220 of current coordinates of the vehicle. The sensor system may be connected to one or more of environment sensors 110, 111, 112, 113, 114, 115, 116, 120, 121, 122, 123, 124, 125, 126, 127, 128, 129, 130 and/or 140 or include them. In an advantageous manner, the sensor system includes a location senor (not shown in FIGS. 1A and 1B), which is designed to receive signals from at least one global satellite navigation system. Alternatively or additionally, the sensor system may include at least one of cameras 110, 111, 112, 113, 114, 115 and/or 116, which is designed to acquire a camera image of the environment, e.g., the forward-facing front camera 110. As an alternative or in addition, the sensor system may include at least one distance sensor, in particular radar sensor 140 and/or ultrasonic sensors 120, 121, 122, 123, 124, 125, 126, 127, 128, 129, 130, which are designed to acquire distances between vehicle 100 and objects 310 in the environment of vehicle 100. Alternatively or additionally, the sensor system preferably includes at least one odometry sensor, the odometry sensor in particular having an rpm sensor, which is advantageously situated on the drive train or on one of the wheel axles of vehicle 100, and/or it has an acceleration sensor and/or a yaw rate sensor of vehicle 100 (not shown in FIGS. 1A and 1B). The at least one odometry sensor is designed to acquire odometry data of the vehicle, or in other words, to acquire, directly and/or indirectly, a movement of vehicle 100, preferably a speed of vehicle 100 and/or a rotational speed of the drive train of vehicle 100 and/or a rotational speed of a wheel of vehicle 100 and/or a steering angle of vehicle 100. In optional step 210, infrastructure information and/or position information is alternatively or additionally received from an infrastructure monitoring device in environment 190 of vehicle 100. This optionally received position information represents the position of vehicle 100 which was ascertained by the infrastructure monitoring device. For the receiving of the position information, the sensor system optionally includes a communications unit (not shown in FIGS. 1A and 1B). Alternatively or additionally, a Car-to-X communications signal between the vehicle and a stationary infrastructure device is acquired in step 210, the Car-to-X communications signal in particular including an emission instant of the signal by a stationary infrastructure device. In step 220, an ascertainment 220 of current coordinates of vehicle 100 takes place. Ascertainment 220 is carried out in particular as a function of the acquired variables of the sensor system. Preferably, ascertainment 220 is carried out as a function of the data from the location sensor of vehicle 100, acquired in optional step 210, for a global satellite navigation system, and/or as a function of the at least one camera image from the at least one camera 110, 111, 112, 113, 114, 115, 116 of vehicle 100 acquired in optional step 210. Alternatively or additionally, ascertainment 220 of the current coordinates of vehicle 100 is carried out as a function of the distance data, acquired in optional step 210, between vehicle 100 and objects in the environment of vehicle 100 and/or as a function of the odometry data of vehicle 100, which are acquired in optional step 210 and include acceleration and/or yaw rate signals of vehicle 100, for example. In other words, ascertainment 220 of the current coordinates of vehicle 100 is carried out based on acquired data of the sensor system of vehicle 100, at least one sensor of the sensor system being used; the current coordinates of vehicle 100 are preferably ascertained based on a combination of different sensor types of the sensor system so that the current coordinates are advantageously ascertained more precisely. Alternatively or additionally, the ascertainment of the coordinates of the vehicle is performed as a function of a propagation time of at least one acquired Car-to-X communications signal between the vehicle and a stationary infrastructure device. For example, if propagation times of at least three acquired different Car-to-X communications signals are acquired between the vehicle and at least one stationary infrastructure device, then the ascertainment of the current coordinates of the vehicle is able to be carried out with the aid of a trigonometric equation as a function of the three acquired propagation times. The ascertainment of the current coordinates alternatively or additionally is performed as a function of the received infrastructure information. The optionally received infrastructure information is emitted by an infrastructure monitoring device in environment 190 of vehicle 100 and acquired or received by the sensor system in optional step 210. The optionally received infrastructure information preferably includes very precise current coordinates of vehicle 100. In optional step 230, data for an ascertainment 240 of an orientation of vehicle 100 are acquired. In optional step 230, an acquisition 230 of signals from at least one inertial measuring unit and/or a magnetometer preferably takes place, the sensor system of vehicle 100 advantageously including the inertial measuring unit and/or the magnetometer. Alternatively or additionally, a characteristic of coordinates of the vehicle 100, ascertained in particular across a predefined time span, is acquired in step 230, the data having been ascertained in step 210 or in the past and being stored in a memory of the vehicle or a cloud or on a server system. The predefined time span, for instance, is less than 10 seconds in relation to a current instant. In step 230, the infrastructure information is alternatively or additionally received, the received infrastructure information being emitted by an infrastructure monitoring device in the environment of vehicle 100. In this optional embodiment, alternatively or additionally to the position of vehicle 100, the infrastructure information represents the orientation of vehicle 100, which was ascertained by the infrastructure monitoring device. In the following step, an ascertainment 240 of the current orientation of vehicle 100 based on the current coordinates of vehicle 100 is carried out. Ascertainment 240 of the orientation of vehicle 100 takes place as a function of signals from the magnetometer and/or as a function of signals from the inertial measuring unit and/or as a function of the acquired characteristic of ascertained coordinates of vehicle 100 and/or as a function of the received infrastructure information. Next, a determination 250 of at least one object 310 in the environment of vehicle 100 and a setpoint position of the object in relation to vehicle 100 is performed. The determination 250 of object 310 and the setpoint position of object 310 is performed as a function of the ascertained coordinates, the ascertained orientation, a predefined position of the environment sensor 110, 111, 112, 113, 114, 115, 116, 120, 121, 122, 123, 124, 125, 126, 127, 128, 129, 130, 140 on vehicle 100, and a map of the environment. The map of the environment includes at least object 310 and a position of object 310. For example, as an intermediate step for the respective environment sensor 110, 111, 112, 113, 114, 115, 116, 120, 121, 122, 123, 124, 125, 126, 127, 128, 129, 130 or 140 provided for the function ascertainment, an acquired subregion of the map is identified or ascertained as a function of the detection range of the respective environment sensor 110, 111, 112, 113, 114, 115, 116, 120, 121, 122, 123, 124, 125, 126, 127, 128, 129, 130 and/or 140 as a function of the ascertained coordinates of vehicle 100 and as a function of the ascertained orientation of vehicle 100 and also as a function of the map. In this acquired subregion of the map, a search for or a determination of an/the object 310 and the setpoint position of object 310 take(s) place. The determination of object 310 is preferably performed as a function of predefined criteria. Preferably, the determination of object 310 is carried out as a function of a type of object 310, a size of object 310 and/or a predefined distance between object 310 and vehicle 100 so that, for instance the setpoint position of determined object 310 does not drop below the predefined distance of object 310 from vehicle 100. Next, an acquisition 260 of the environment of vehicle 100 takes place with the aid of the at least one environment sensor 110, 111, 112, 113, 114, 115, 116, 120, 121, 122, 123, 124, 125, 126, 127, 128, 129, 130 and/or 140. In step 260, in particular camera images and/or distances between vehicle 100 and objects in the environment of vehicle 100 are acquired, the distances being able to be acquired with the aid of ultrasonic sensors 120, 121, 122, 123, 124, 125, 126, 127, 128, 129, 130 and/or radar sensor 140, and/or as a function of a sequence of camera images with the aid of cameras 110, 111, 112, 113, 114, 115, 116 and/or with the aid of a stereo camera, for instance. Next, in step 270, environment data are generated as a function of the environment acquired in step 260. The environment data, for example, represent the distances, acquired in step 260, between objects in environment 190 of vehicle 100 and vehicle 100 as well as the objects identified in the environment of vehicle 100, which are preferably detected as a function of acquired camera images from cameras 110, 111, 112, 113, 114, 115 and/or 116, the detected objects in particular being allocated to the distances. In step 280, depending on the generated environment data, an actual position of object 310, determined in step 240, in environment 190 of vehicle 100 is detected or ascertained as a function of the environment data.

Then, a detection 290 of an operating capability of environment sensor 110, 111, 112, 113, 114, 115, 116, 120, 121, 122, 123, 124, 125, 126, 127, 128, 129, 130 or 140 takes place by comparing the detected or ascertained actual position of object 310 with the setpoint position of object 310 determined on the basis of the map. As an alternative to detection 290 of the operating capability or after the detection 290 of the operating capability of the environment sensor, a calibration 291 of environment sensor 110, 111, 112, 113, 114, 115, 116, 120, 121, 122, 123, 124, 125, 126, 127, 128, 129, 130 or 140 is performed as a function of the actual position and the setpoint position. After the operating capability of the environment sensor has been detected, a deactivation 292 of environment sensor 110, 111, 112, 113, 114, 115, 116, 120, 121, 122, 123, 124, 125, 126, 127, 128, 129, 130 or 140 as a function of the detected operating capability may be carried out in an optional step 292. In another optional step 293, after the operating capability of the environment sensor has been detected, an activation 293 of a safety sensor and/or of an alternative environment monitoring system of vehicle 100 is able to be provided as a function of the detected operating capability, the safety sensor at least partly replacing environment sensor 110, 111, 112, 113, 114, 115, 116, 120, 121, 122, 123, 124, 125, 126, 127, 128, 129, 130 or 140. In a further optional step 294, after the operating capability of the environment sensors has been detected, an adaptation 294 of a display of an environment model for a user of vehicle 100 is able to take place as a function of the detected operating capability. In a further optional step 295, a control of a steering system and/or a control of a speed of vehicle 100 is able to be adapted as a function of the detected operating capability after the operating capability of the environment sensor has been detected.

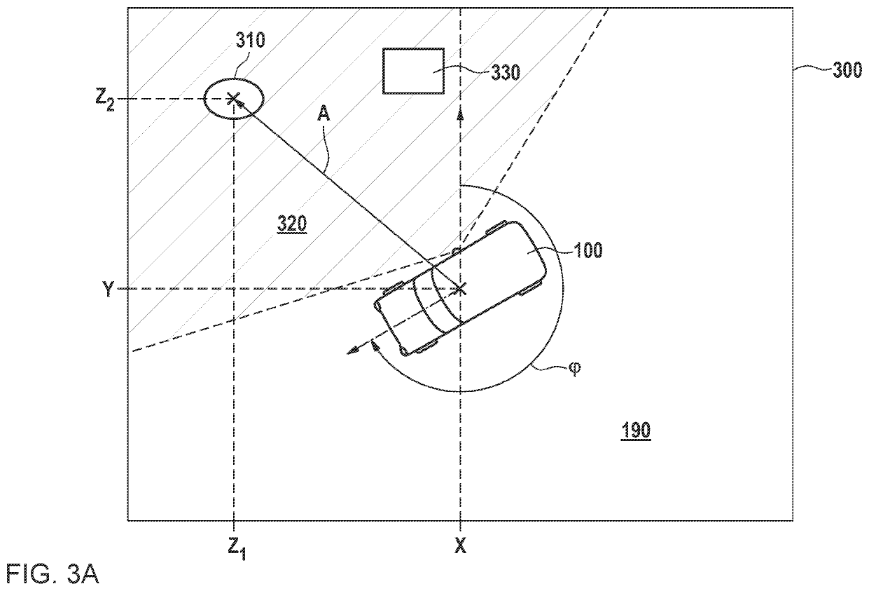

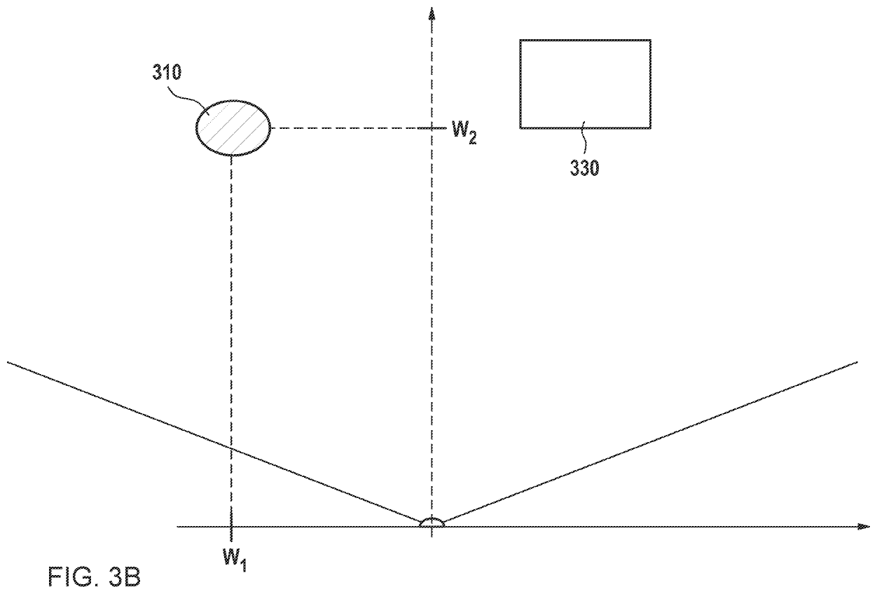

In FIG. 3A, a visualization of the essential steps of the method leading up to determination 250 of the at least one object 310 in environment 190 and its setpoint position as a function of map 300 of environment 190 is schematically illustrated. FIG. 3A shows map 300 of environment 190 in a top view. After ascertainment 220 of current coordinates X, Y of vehicle 100, the position of the vehicle on map 300 is known, see the simplified representation of vehicle 100 on map 300 in FIG. 3A. Following ascertainment 220 of current orientation φ of vehicle 100, such as the yaw angle of vehicle 100, the orientation of vehicle 100 on map 300 is known, see the simplified representation of vehicle 100 on map 300 in FIG. 3A. As a result, for a predefined environment sensor 110, 111, 112, 113, 114, 115, 116, 120, 121, 122, 123, 124, 125, 126, 127, 128, 129, 130 or 140 to be checked and/or calibrated, whose predefined position on vehicle 100 is known, its detection range or subregion 320 of map 300, which is able to be acquired by environment sensor 110, 111, 112, 113, 114, 115, 116, 120, 121, 122, 123, 124, 125, 126, 127, 128, 129, 130 or 140, is known as well. The detection range of environment 190 of environment sensor 110, 111, 112, 113, 114, 115, 116, 120, 121, 122, 123, 124, 125, 126, 127, 128, 129, 130 or 140 is represented by subregion 320 of map 300. In this subregion of map 300, which is acquired by environment sensor 110, 111, 112, 113, 114, 115, 116, 120, 121, 122, 123, 124, 125, 126, 127, 128, 129, 130 or 140, a matching object is searched for or determined in order to check the operating capability or to detect the operating capability and/or to calibrate respective environment sensor 110, 111, 112, 113, 114, 115, 116, 120, 121, 122, 123, 124, 125, 126, 127, 128, 129, 130 or 140. The determination of object 310 preferably takes place as a function of predefined criteria. If an object 310 was found or identified or determined, then the setpoint position or setpoint coordinates Z1, Z2 with regard to the vehicle are able to be ascertained as a function of current coordinates X, Y of vehicle 100.

FIG. 3B schematically illustrates a detection range of the predefined environment sensor 110, 111, 112, 113, 114, 115, 116, 120, 121, 122, 123, 124, 125, 126, 127, 128, 129, 130 or 140 or the environment sensor to be checked or calibrated, or a visualization of the generated environment data, the environment data including semantic information. In other words, determined object 310 and optionally further objects 330 are detected in a camera image from a camera 110, 111, 112, 113, 114, 115, 116, for instance, and allocated to the distance data as semantic information. These environment data including this semantic information are shown in FIG. 3B. Object 310 is partially detected in the distance data between the vehicle and objects in the environment of vehicle 190, see FIG. 3B. After object 310 has been detected, preferably by a trained machine-based detection method or an artificial intelligence such as a neural network, as a function of a camera image acquired with the aid of a camera 110, 111, 112, 113, 114, 115, 116, object information is allocated to the distance data included in the environment data. Thus, the actual position W1, W2 of object 310 in relation to vehicle 100 is able to be ascertained or identified as a function of the environment data. In step 290, the operating capability of environment sensor 110, 111, 112, 113, 114, 115, 116, 120, 121, 122, 123, 124, 125, 126, 127, 128, 129, 130 or 140 is ascertained or identified by a comparison of actual position Wl, W2 with setpoint position Z1, Z2. Alternatively or additionally, environment sensor 110, 111, 112, 113, 114, 115, 116, 120, 121, 122, 123, 124, 125, 126, 127, 128, 129, 130 or 140 is calibrated in step 291 by comparing the actual position W1, W2 with setpoint position Z1, Z2. Other objects with the exception of determined object 310 are not taken into account in the detection 290 of the operating capability and/or calibration 291 of environment sensor 110, 111, 112, 113, 114, 115, 116, 120, 121, 122, 123, 124, 125, 126, 127, 128, 129, 130 or 140. Determined object 310 is preferably large and stationary such as a traffic light, an advertising pillar or a building.

1-15. (canceled)

16. A method for detecting an operating capability of an environment sensor of a vehicle, the method comprising the following steps:
ascertaining current coordinates of the vehicle;
ascertaining a current orientation of the vehicle;
determining at least one object in an environment of the vehicle and a setpoint position of the object in relation to the vehicle as a function of the ascertained current coordinates, the ascertained current orientation, a predefined position of the environment sensor on the vehicle, and a map of the environment, the map including at least the object and a position of the object;
acquiring the environment of the vehicle using the environment sensor;
generating environment data as a function of the acquired environment;
detecting an actual position of the determined object in the environment of the vehicle as a function of the environment data; and
(i) detecting an operating capability of the environment sensor by comparing the actual position of the object with the setpoint position of the object, and/or (ii) calibrating the environment sensor as a function of the actual position of the object and the setpoint position of the object.

17. The method as recited in claim 16, wherein the ascertainment of the current coordinates of the vehicle is carried out:
as a function of acquired signals, which are received with the aid of using a location sensor for a global satellite navigation system, and/or,
as a function of at least one camera image of a camera, and/or
as a function of acquired distance data between the vehicle and objects in the environment of the vehicle, and/or
as a function of odometry data of the vehicle, and/or
as a function of at least one propagation time of a Car-to-X communications signal between the vehicle and a stationary infrastructure device.

18. The method as recited in claim 16, wherein the ascertainment of the current orientation of the vehicle is performed:
as a function of signals from a magnetometer, and/or
as a function of signals from at least one inertial measuring unit, and/or
as a function of a characteristic of ascertained coordinates of the vehicle, ascertained across a predefined time span.

19. The method as recited in claim 16, wherein the ascertainment of the current coordinates of the vehicle and/or the ascertainment of the current orientation takes place as a function of received position information, the received position information being sent out by a stationary infrastructure monitoring device in the environment of the vehicle.

20. The method as recited in claim 16, wherein the position of the object indicated on the map has an accuracy of less than one meter.

21. The method as recited in claim 16, wherein the accuracy of the position of the object on the map is less than ten centimeters.

22. The method as recited in claim 16, wherein the accuracy of the position of the object on the map is less than one centimeter.

23. The method as recited in claim 16, wherein the setpoint position of the determined object does not drop below a predefined distance of the object from the vehicle.

24. The method as recited in claim 16, wherein the detection of the actual position of the determined object in the environment of the vehicle takes place as a function of the environment data using a trained machine-based detection, the trained machine-based detection including using a neural network.

25. The method as recited in claim 16, wherein after the operational capability has been detected, the following step is carried out:
deactivating the environment sensor as a function of the detected operating capability.

26. The method as recited in claim 16, wherein after the operating capability has been detected, the following step is carried out:
activating a safety sensor and/or an alternative environment monitoring system of the vehicle (100) as a function of the detected operating capability, the safety sensor at least partly replacing the environment sensor.

27. The method as recited in claim 16, wherein after the operating capability has been detected, the following step is carried out:
adapting a display of an environment model for a user of the vehicle as a function of the detected operating capability.

28. The method as recited in claim 16, wherein after the operating capability has been detected, the following step is carried out:
adapting a control of a steering system and/or a speed of the vehicle, as a function of the detected operating capability.

29. The method as recited in claim 16, wherein the method is carried out immediately after a detected accident of the vehicle.

30. A control unit, which includes a computing unit, the computing unit being configured to be connected to an environment sensor, the environment sensor being configured to be placed at a predefined position of a vehicle, the computing unit configured to:
ascertain current coordinates of a vehicle as a function of a signal from a location sensor of the vehicle;
ascertain a current orientation of the vehicle;
determine at least one object in an environment of the vehicle and a setpoint position of the object in relation to the vehicle as a function of the ascertained current coordinates, the ascertained current orientation, the predefined position of the environment sensor on the vehicle, and a map of the environment, the map including the at least one object and a position of the object;
generate environment data as a function of an environment acquired using the environment sensor;
ascertain an actual position of the determined object in the environment of the vehicle as a function of the environment data; and
(i) detect an operating capability of the environment sensor by comparing the actual position of the object with the setpoint position of the object, and/or (ii) calibrate the environment sensor as a function of the actual position of the object and the setpoint position of the object.

31. A vehicle, comprising:
a location sensor for a global navigation satellite system;
an environment sensor which is situated in a predefined position of the vehicle; and
a control unit, which includes a computing unit, the computing unit connected to the environment sensor, the computing unit configured to:
ascertain current coordinates of a vehicle as a function of a signal from a location sensor of the vehicle;
ascertain a current orientation of the vehicle;
determine at least one object in an environment of the vehicle and a setpoint position of the object in relation to the vehicle as a function of the ascertained current coordinates, the ascertained current orientation, the predefined position of the environment sensor on the vehicle, and a map of the environment, the map including the at least one object and a position of the object;
generate environment data as a function of an environment acquired using the environment sensor;
ascertain an actual position of the determined object in the environment of the vehicle as a function of the environment data; and
(i) detect an operating capability of the environment sensor by comparing the actual position of the object with the setpoint position of the object, and/or (ii) calibrate the environment sensor as a function of the actual position of the object and the setpoint position of the object.

32. The vehicle as recited in claim 31, wherein the vehicle additionally includes at least the following component:
an odometry sensor including an rpm sensor and/or an acceleration sensor and/or a yaw rate sensor,
a communications unit, which is configured to receive position information from a stationary infrastructure monitoring device, and/or
a Car-to-X communications unit, which is configured to receive a communications signal from a stationary infrastructure device.
